(19) United States
(12) Patent Application Publication
(10) Pub. No.: US 2026/0330876 A1
(43) Pub. Date: Oct. 22, 2026

(54) METHOD AND ELECTRONIC DEVICE FOR RECOGNIZING HAND GESTURE

(71) Applicant: Samsung Electronics Co., Ltd., Suwon-si (KR)

(72) Inventors: Vishakha S R, Bangalore (IN); Bindigan Hariprasanna Pawan PRASAD, Bangalore (IN); Green Rosh K S, Bangalore (IN); Akula JAYAPRAKASH, Bangalore (IN); Sungsoo CHOI, Suwon-si (KR); Hyuntaek WOO, Suwon-si (KR); Chaeeun LEE, Suwon-si (KR); Beomsu KIM, Suwon-si (KR)

(21) Appl. No.: 19/689,324

(22) Filed: May 27, 2026

Related U.S. Application Data
(63) Continuation of application No. PCT/KR2024/020690, filed on Dec. 19, 2024.

(30) Foreign Application Priority Data
Dec. 20, 2023 (IN) 202341087403

(51) Int. Cl. G06V 40/20; G06F 3/01; G06T 7/194; G06T 7/246

(52) U.S. Cl. CPC G06V 40/28; G06F 3/017; G06T 7/194; G06T 7/246

(57) ABSTRACT

A method for determining a gesture of a user is provided. The method includes capturing, by an electronic device, a plurality of frames including a part of a body of the user, estimating, by the electronic device, a plurality of background planes for each frame of the plurality of frames, based on the estimation, identifying, by the electronic device, a movement of the plurality of background planes, based on the identifying of the movement of the plurality of background planes, estimating, by the electronic device, a movement direction of the electronic device, and based on the estimated movement direction of the electronic device, determining, by the electronic device, the gesture of the user while the gesture is detected by the electronic device.

### CROSS-REFERENCE TO RELATED APPLICATION(S)

This application is a continuation application, claiming priority under 35 U.S.C. § 365(c), of an International application No. PCT/KR2024/020690, filed on Dec. 19, 2024, which is based on and claims the benefit of an Indian Patent Application number 202341087403, filed on Dec. 20, 2023, in the Indian Intellectual Property Office, the disclosure of which is incorporated by reference herein in its entirety.

### BACKGROUND

### 1. Field

The disclosure relates to a hand gesture recognizing method and system. More particularly, the disclosure relates to a method and an electronic device for recognizing hand gesture.

### 2. Description of Related Art

Currently, hand gestures are getting popular by the day with the advent of wearable devices. The hand gestures will be a primary mode of feedback and control for modern day devices such as head mounted display (HMD). With this in mind, it is of utmost importance to have a robust hand gesture recognition system on the devices.

The above information is presented as background information only to assist with an understanding of the disclosure. No determination has been made, and no assertion is made, as to whether any of the above might be applicable as prior art with regard to the disclosure.

### SUMMARY

The hand gesture recognition gets very challenging when even an electronic device (e.g., camera or the like) is in moving. With both the hand and the electronic device in motion it gets even harder to understand the hand gesture. With the wearable devices such as head mounted displays (HMDs), this is going to be a common problem and requires a robust solution that can recognize the hand gesture irrespective of the electronic device motion.

Further, accurate hand gesture recognition is very challenging when the electronic device (e.g., camera or the like) itself is in motion. In applications where accurate hand gesture recognition is a must, the camera motion will result in inaccuracies and might lead to false positives. This is even more evident in the wearable devices where the user of the wearable devices tends to move along with their hand while doing the gestures.

Aspects of the disclosure are to address at least the above-mentioned problems and/or disadvantages and to provide at least the advantages described below. Accordingly, an aspect of the disclosure is to provide a method and an electronic device for recognizing hand gesture.

Additional aspects will be set forth in part in the description which follows and, in part, will be apparent from the description, or may be learned by practice of the presented embodiments.

FIG. 1 is an example illustration (100) in which the electronic device does not able to recognize the hand gesture, according to the related art.

Initially, at operation 102, the hand action is provided without device motion. The hand action is clearly identified as swipe left to right direction. The black color line indicates the hands position in every frame. The colored shapes are the surface planes in the scene. At operation 104, the hand action is provided with the device motion. Based on the exiting methods, the hand action cannot be clearly identified as the electronic device (e.g., camera or the like) moved along with the hand. The black color line indicates the hands position in every frame. The colored shapes are the surface planes in the scene.

In accordance with an aspect of the disclosure, a method for determining a gesture of a user is provided. The method includes capturing, by an electronic device, a plurality of frames including a part of a body of the user, estimating, by the electronic device, a plurality of background planes for each frame of the plurality of frames, based on the estimation, identifying, by the electronic device, a movement of the plurality of background planes, based on the identifying of the movement of the plurality of background planes, estimating, by the electronic device, a movement direction of the electronic device, and based on the estimated movement direction of the electronic device determining, by the electronic device, the gesture of the user while the gesture is detected by the electronic device.

In an embodiment, the plurality of background planes is estimated based on a surface normal estimation. The surface normal estimation is performed by detecting at least one feature in the plurality of captured frames.

In an embodiment, the surface normal estimation is performed by using a data driven model.

In an embodiment, the movement of the plurality of background planes in each of the frames is stored in memory of the electronic device. The stored movement of the plurality of background planes is referred as a reference movement used to determine the exact hand gesture.

In an embodiment, the hand gesture is performed while the electronic device is moving along with the hand.

In accordance with another aspect of the disclosure, a method for determining a hand gesture is provided. The method includes capturing, by an electronic device, a plurality of frames including a part of a body of the user, detecting, by the electronic device, that the electronic device is moving along with the part of a body, obtaining, by the electronic device, a surface plane information to estimate a plurality of background planes associated with each frame of the plurality of frames, measuring, by the electronic device, a movement of the plurality of background planes to estimate a movement direction of the electronic device, determining, by the electronic device, a relative motion between the electronic device and the part of the body by correlating the surface plane information and the movement of the plurality of background planes, and determining, by the electronic device, the gesture based on the determined relative motion.

In an embodiment, the surface plane information is performed by detecting at least one feature in the plurality of captured frames. The surface plane information is performed by using a data driven model.

In accordance with another aspect of the disclosure, an electronic device is provided. The electronic device includes memory, comprising one or more storage media, storing instructions, and at least one processor communicatively coupled to the memory, wherein the instructions, when executed by the at least one processor individually or collectively, cause the electronic device to capture, by the electronic device, a plurality of frames including a part of a body of a user, estimate, by the electronic device, a plurality of background planes for each frame of the plurality of frames, based on the estimation, identify, by the electronic device, a movement of the plurality of background planes, based on the identifying of the movement of the plurality of background planes, estimate, by the electronic device, a movement direction of the electronic device, and based on the estimated movement direction of the electronic device, determine, by the electronic device, a gesture of the user while the gesture is detected by the electronic device.

In accordance with another aspect of the disclosure, an electronic device is provided. The electronic device includes memory, comprising one or more storage media, storing instructions, and at least one processor communicatively coupled to the memory, wherein the instructions, when executed by the at least one processor individually or collectively, cause the electronic device to, capture a plurality of frames including a part of a body of a user, detect that the electronic device is moving along with the part of the body, obtain a surface plane information to estimate a plurality of background planes associated with each frame of the plurality of frames measure a movement of the plurality of background planes to estimate a movement direction of the electronic device determine a relative motion between the electronic device and the part of the body by correlating the surface plane information and the movement of the plurality of background planes, and based on the determined relative motion, determine a gesture.

In accordance with another aspect of the disclosure, one or more non-transitory computer-readable storage media storing one or more computer programs including computer-executable instructions that, when executed by at least one processor of an electronic device individually or collectively, cause the electronic device to perform operations are provided. The operations include capturing, by an electronic device, a plurality of frames including a part of a body of a user, estimating, by the electronic device, a plurality of background planes for each frame of the plurality of frames, based on the estimation, identifying, by the electronic device, a movement of the plurality of background planes, based on the identifying of the movement of the plurality of background planes, estimating, by the electronic device, a movement direction of the electronic device, and based on the estimated movement direction of the electronic device, determining, by the electronic device, a gesture of the user while the gesture is detected by the electronic device.

The principal aspect of embodiments herein is to provide an electronic device and a method for recognizing a hand gesture.

Another aspect of embodiments herein is to perform the hand gesture refinement and recognition when the electronic device (e.g., HMD or the like) is moving along with the hand.

Another aspect of embodiments herein is to use surface plane information to estimate background planes and measure movement of background planes to estimate trajectory of the electronic device.

Another aspect of embodiments herein is to provide a relative motion between the electronic device and the hand correlated from the surface plane information and background plane movements to refine the hand gestures.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is an example illustration in which an electronic device does not able to recognize a hand gesture, according to the related art;

FIG. 2 shows various hardware components of the electronic device, according to an embodiment of the disclosure;

FIGS. 3 and 4 are flow charts illustrating a method for recognizing the hand gesture, according to various embodiments of the disclosure;

FIG. 5 is an example illustration in which the electronic device can able to recognize the hand gesture, according to an embodiment of the disclosure;

FIG. 6 is an example illustration in which a surface normal estimation is depicted, according to an embodiment of the disclosure;

FIG. 7 is an example illustration in which the surface normal estimation is depicted in conjunction with FIG. 6, according to an embodiment of the disclosure;

FIG. 8 is an example flow chart illustrating a method for performing the accurate hand gesture recognition based on a surface normal trajectory estimation, according to an embodiment of the disclosure;

FIG. 9 is an example illustration in which hand pose revision is estimated, according to an embodiment of the disclosure;

FIGS. 10 and 11 are example illustrations in which the electronic device recognizes the hand gesture, according to various embodiments of the disclosure;

FIG. 12 is an example illustration in which a head mounted display (HMD) moves with the hand while playing a virtual musical instrument, according to an embodiment of the disclosure;

FIG. 13 is an example illustration in which the HMD moves with the hand while dragging objects in multiple windows in a virtual desktop/virtual presentations, according to an embodiment of the disclosure;

FIG. 14 is an example illustration in which the HMD moves with the hand while playing a VR games, according to an embodiment of the disclosure;

FIG. 15 is a block diagram illustrating an electronic device 1501 in a network environment 1500 according to an embodiment of the disclosure; and

FIGS. 16A and 16B are diagrams illustrating a wearable device (e.g., the electronic device) according to various embodiments of the disclosure.

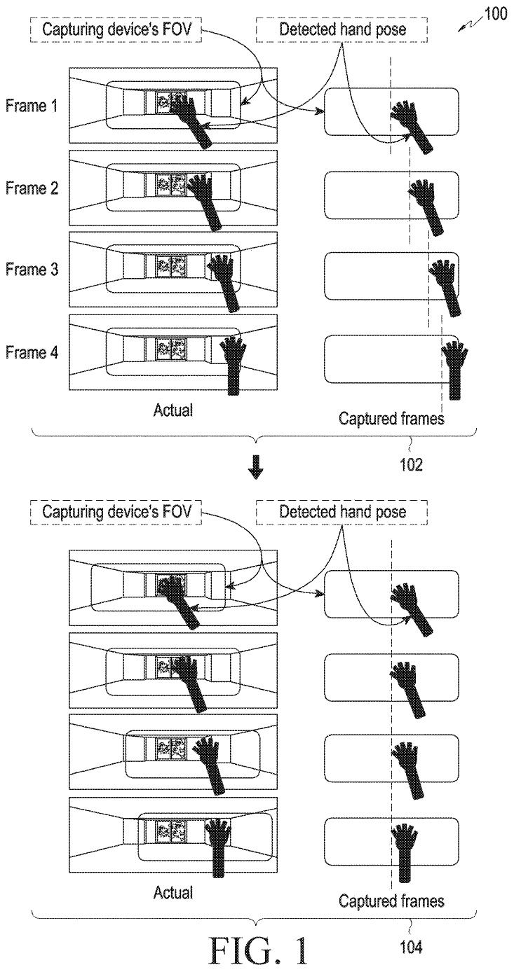

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It is to be understood that the terminology used herein is for the purposes of describing particular embodiments only and is not intended to be limiting. The terms “comprising”, “having” and “including” are to be construed as open-ended terms unless otherwise noted.

The words/phrases “exemplary”, “example”, “illustration”, “in an instance”, “and the like”, “and so on”, “etc.”, “etcetera”, “e.g.,”, “i.e.,” are merely used herein to mean “serving as an example, instance, or illustration.” Any embodiment or implementation of the subject matter described herein using the words/phrases “exemplary”, “example”, “illustration”, “in an instance”, “and the like”, “and so on”, “etc.”, “etcetera”, “e.g.,”, “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. In an example, the flowcharts/sequence diagrams illustrate the method in terms of the steps required for understanding of aspects of the embodiments as disclosed herein. Furthermore, in terms of the construction of the device, one or more components of the device may have been represented in the drawings by conventional symbols, and the drawings may show only those specific details that are pertinent to understanding the embodiments so as not to obscure the drawings with details that will be readily apparent to those of ordinary skill in the art having the benefit of the description herein. In terms of the system, one or more components/modules which comprise the system may have been represented in the drawings by conventional symbols, and the drawings may show only those specific details that are pertinent to understanding the embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the disclosure should be construed to extend to any modifications, equivalents, and substitutes in addition to those which are particularly set out in the accompanying drawings and the corresponding description. Usage of words such as first, second, third etc., to describe components/elements/steps is for the purposes of this description and should not be construed as sequential ordering/placement/occurrence unless specified otherwise.

The embodiments herein achieve a method for recognizing a hand gesture. The method includes capturing, by an electronic device, a plurality of frames associated with a hand, when the hand is performing the hand gesture. Further, the method includes estimating, by the electronic device, a plurality of background planes for each frame of the plurality of frames. The hand gesture is performed in front of the plurality of background planes. The method includes determining, by the electronic device, a movement of the plurality of background planes. Further, the method includes determining, by the electronic device, a movement of the electronic device based on the movement of the plurality background planes. Further, the method includes determining, by the electronic device, the hand gesture, upon measuring a movement of the hand while performing the hand gesture relative to the movement of the electronic device.

Unlike conventional methods, the proposed method can be used to increase the accuracy in hand gesture recognition where head movements are more. Since the camera will be capturing the entire image throughout the action sequence, surface normal can be accurately estimated by feature detection in continuous frames. Using the surface plane normal information, the proposed method can be used to estimate the required transformations for hand pose correction that aids the hand gesture recognizing controller.

The proposed method can be used to detect the camera motion in 3D. The proposed method can be used to track the large camera motion and the motion estimation using plane surface normal, works even when only planes are in the background. The proposed method can be used to detect the surface plane normal and use its warping matrix to correct the estimated hand pose for accurate action recognition.

The disclosure is explained in the context of hand gesture or the hand pose. But, the disclosure is not limited only to the hand gesture or the hand pose, but this is also applicable to a finger gesture.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

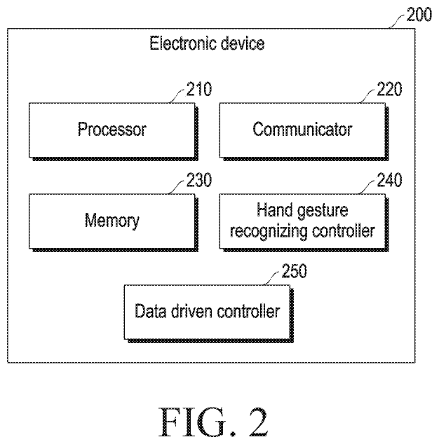

Referring now to the drawings, and more particularly to FIGS. 2 to 14, where similar reference characters denote corresponding features consistently throughout the figures, there are shown embodiments.

FIG. 2 shows various hardware components of the electronic device (200), according to an embodiment of the disclosure.

The electronic device (200) can be, for example, but not limited to a head mounted display (HMD), a visual see through (VST) device, a virtual reality (VR) device, an extended reality (XR) device, an augmented reality (AR) device, a mixed reality (MR) device, a smart phone, a notebook, a device-to-device (D2D) device, a vehicle to everything (V2X) device, a foldable phone, a smart television (TV), a tablet, an immersive device, and an internet of things (IoT) device.

In an embodiment, the electronic device (200) includes a processor (210), a communicator (220), memory (230), a hand gesture recognizing controller (240) and a data driven controller (250). The processor (210) is coupled with the communicator (220), the memory (230), the hand gesture recognizing controller (240) and the data driven controller (250).

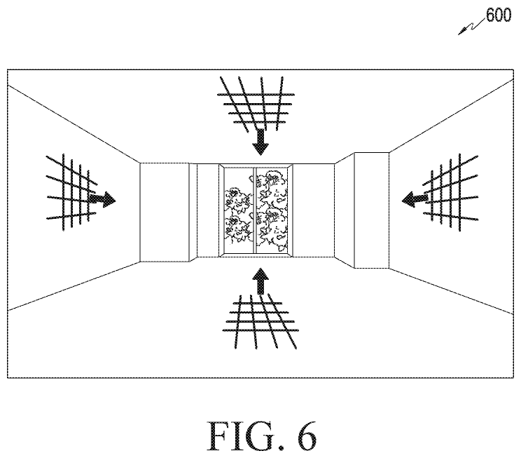

In an embodiment, the hand gesture recognizing controller (240) captures a plurality of frames associated with a hand, when the hand is performing a hand gesture (e.g., swipe gesture, pinch gesture or the like). The hand gesture is performed while the electronic device (200) is moving along with the hand. Further, the hand gesture recognizing controller (240) estimates a plurality of background planes for each frame of the plurality of frames. The hand gesture is performed in front of the plurality of background planes. The plurality of background planes is estimated based on a surface normal estimation. The surface normal estimation is explained in FIG. 6. In an example, the surface normal estimation is performed by detecting a feature (e.g., corner portion of the image, a number of objects in the image or the like) in the plurality of captured frames. The surface normal estimation is performed by using a data driven model (e.g., Artificial Intelligence (AI) based data driven model, machine learning (ML) based data driven model or the like). The movement of the plurality of background planes in each of the frames is stored in the memory (230) of the electronic device (200). The stored movement of the plurality of background planes is referred as a reference movement used to determine the exact hand gesture.

The hand gesture recognizing controller (240) determines a movement of the plurality of background planes. Based on the movement of the plurality background planes, the hand gesture recognizing controller (240) determines a movement of the electronic device (200). Further, the hand gesture recognizing controller (240) determines the hand gesture, upon measuring a movement of the hand while performing the hand gesture relative to the movement of the electronic device (200).

In another embodiment, the hand gesture recognizing controller (240) captures the plurality of frames associated with the hand, when the hand is performing the hand gesture. Further, the hand gesture recognizing controller (240) detects that the electronic device (200) is moving along with the hand. Further, the hand gesture recognizing controller (240) obtains the surface plane information to estimate the plurality of background planes associated with each frame of the plurality of frames. The surface plane information is obtained by detecting the feature in the plurality of captured frames. The surface plane information is obtained by using the data driven model. The hand gesture recognizing controller (240) measures the movement of the plurality of background planes to estimate the movement direction of the electronic device (200). Further, the hand gesture recognizing controller (240) determines the relative motion between the electronic device (200) and the hand by correlating the surface plane information and the movement of the plurality of background planes. Further, the hand gesture recognizing controller (240) refines and recognizes the hand gesture based on the determined relative motion.

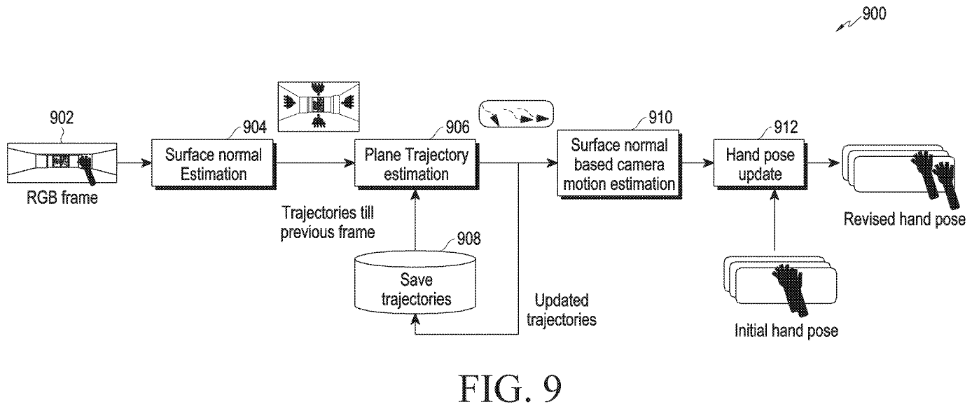

The hand gesture recognizing controller (240) can be used to detect the camera motion in the three-dimensional (3D). The hand gesture recognizing controller (240) can be used to track the large camera motion and the motion estimation using plane surface normal, works even when only planes are in the background. The hand gesture recognizing controller (240) can be used to detect the surface plane normal and use its warping matrix to correct the estimated hand pose for accurate action recognition. The warping matrix basically means to use the obtained rotation and translation of the surface planes to correct the estimated hand pose. Correction of the estimated hand pose is explained in FIG. 9.

The hand gesture recognizing controller (240) can be used to increase the accuracy in hand gesture recognition where the head movements are more. Since the camera will be capturing the entire image throughout the action sequence, a surface normal can be accurately estimated by the feature detection in continuous frames. Using the surface plane normal information, the hand gesture recognizing controller (240) can be used to estimate the required transformations for hand pose correction.

The hand gesture recognizing controller (240) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The processor (210) may, for example, include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (210) may include multiple cores and is configured to execute the instructions stored in the memory (230).

The processor (210) is configured to execute instructions stored in the memory (230) and to perform various processes. The communicator (220) is configured for communicating internally between internal hardware components and with external devices via one or more networks. The memory (230) also stores instructions to be executed by the processor (210). The memory (230) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (230) may, in some examples, be considered a non-transitory storage medium. The term “non-transitory” may indicate that the storage medium is not embodied in a carrier wave or a propagated signal. However, the term “non-transitory” should not be interpreted that the memory (230) is non-movable. In certain examples, a non-transitory storage medium may store data that can, over time, change (e.g., in random access memory (RAM) or cache).

At least one of the pluralities of modules/controller may be implemented through an Artificial intelligence (AI) model using a data driven controller (250). The data driven controller (250) can be a machine learning (ML) model based controller and AI model based controller. A function associated with the AI model may be performed through the non-volatile memory, the volatile memory, and the processor (210). The processor (210) may include one or a plurality of processors. At this time, one or a plurality of processors may be a general purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU).

The one or a plurality of processors control the processing of the input data in accordance with a predefined operating rule or AI model stored in the non-volatile memory and the volatile memory. The predefined operating rule or artificial intelligence model is provided through training or learning.

Here, being provided through learning means that a predefined operating rule or AI model of a desired characteristic is made by applying a learning algorithm to a plurality of learning data. The learning may be performed in a device itself in which AI according to an embodiment is performed, and/o may be implemented through a separate server/system.

The AI model may, for example, comprise of a plurality of neural network layers. Each layer has a plurality of weight values, and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning algorithm is a method for training a predetermined target device (for example, a robot) using a plurality of learning data to cause, allow, or control the target device to make a determination or prediction. Examples of learning algorithms include, but are not limited to, supervised learning, unsupervised learning, semi-supervised learning, or reinforcement learning.

Although the FIG. 2 shows various hardware components of the electronic device (200) but it is to be understood that other embodiments are not limited thereon. In other embodiments, the electronic device (200) may include less or more number of components. Further, the labels or names of the components are used only for illustrative purpose and does not limit the scope of the disclosure. One or more components can be combined together to perform same or substantially similar function in the electronic device (200).

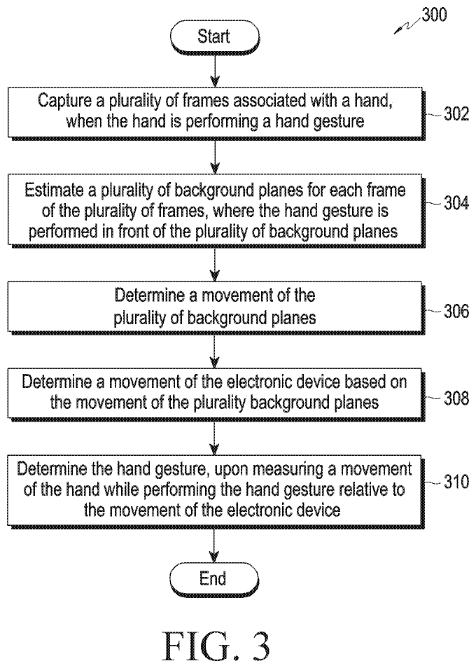

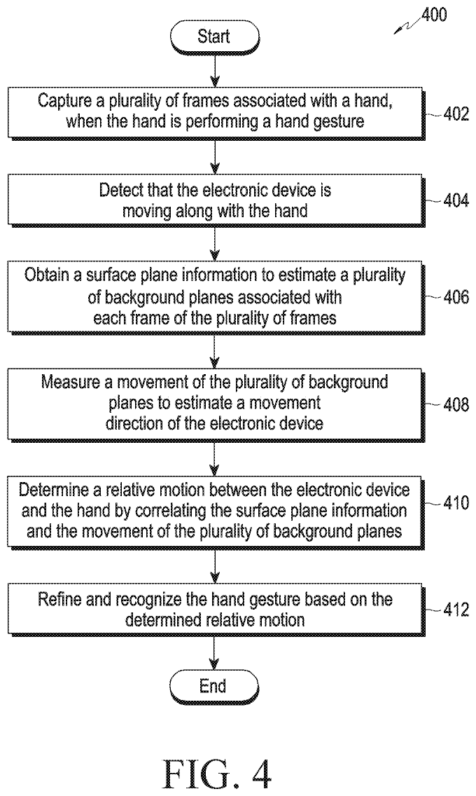

FIGS. 3 and 4 are flow charts (300 and 400) illustrating a method for recognizing the hand gesture, according to various embodiments of the disclosure.

Referring to FIG. 3, the operations (302-310) are handled by the hand gesture recognizing controller (240). At operation 302, the method includes capturing the plurality of frames associated with the hand, when the hand is performing the hand gesture. At operation 304, the method includes estimating the plurality of background planes for each frame of the plurality of frames. The hand gesture is performed in front of the plurality of background planes. At operation 306, the method includes determining the movement of the plurality of background planes. At operation 308, the method includes determining the movement of the electronic device (200) based on the movement of the plurality background planes. At operation 310, the method includes determining the hand gesture, upon measuring a movement of the hand while performing the hand gesture relative to the movement of the electronic device (200).

Referring to FIG. 4, the operations (402-412) are handled by the hand gesture recognizing controller (240). At operation 402, the method includes capturing the plurality of frames associated with the hand, when the hand is performing the hand gesture. At operation 404, the method includes detecting that the electronic device (200) is moving along with the hand. At operation 406, the method includes obtaining the surface plane information to estimate the plurality of background planes associated with each frame of the plurality of frames. At operation 408, the method includes measuring the movement of the plurality of background planes to estimate the movement direction of the electronic device (200). At operation 410, the method includes determining the relative motion between the electronic device (200) and the hand by correlating the surface plane information and the movement of the plurality of background planes. At operation 412, the method includes refining and recognizing the accurate hand gesture based on the determined relative motion.

The proposed method can be used to detect the camera motion in the 3D. The proposed method can be used to track the large camera motion and the motion estimation using plane surface normal, works even when only planes are in the background. The proposed method can be used to detect the surface plane normal and use its warping matrix to correct the estimated hand pose for accurate action recognition.

The proposed method can be used to increase the accuracy in hand gesture recognition where head movements are more. Since the camera will be capturing the entire image throughout the action sequence, surface normal can be accurately estimated by feature detection in continuous frames. Using the surface plane normal information, the proposed method can be used to estimate the required transformations for hand pose correction that aids the hand gesture recognizing controller.

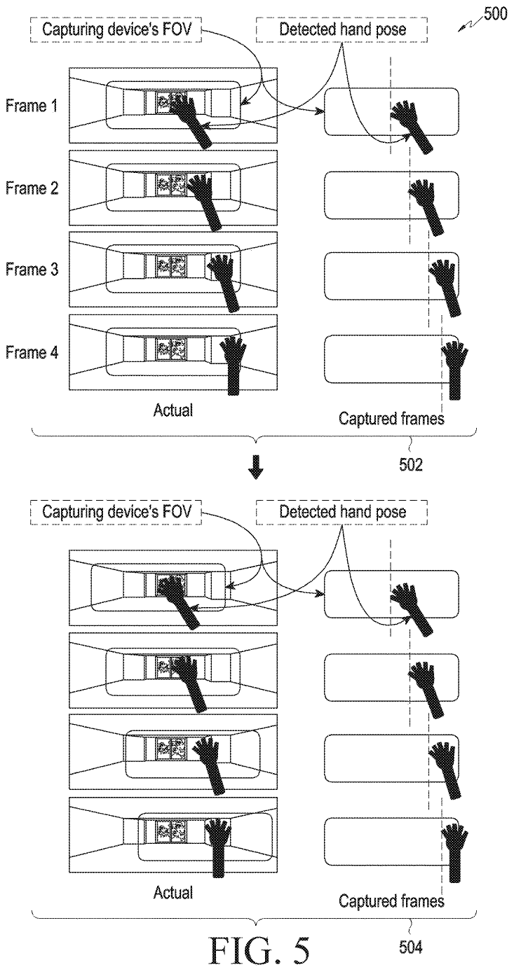

FIG. 5 is an example illustration (500) in which the electronic device (200) can able to recognize the hand gesture, according to an embodiment of the disclosure.

Initially, at operation 502, the hand action is provided without device motion. The hand action is clearly identified as swipe left to right. The black color line indicates the hands position in every frame. The colored shapes are the surface planes in the scene. At operation 504, the hand action is provided with the device motion. Based on the proposed method, The proposed method can be used to correct the hand poses to do accurate hand action recognition. The black color line indicates the hands position in every frame.

FIG. 6 is an example illustration (600) in which a surface normal estimation is depicted, according to an embodiment of the disclosure.

Referring to FIG. 6, surface normal are vectors pointing in a direction perpendicular to the plane surface. These normal can be accurately estimated for all plane surfaces in a scene using AI techniques.

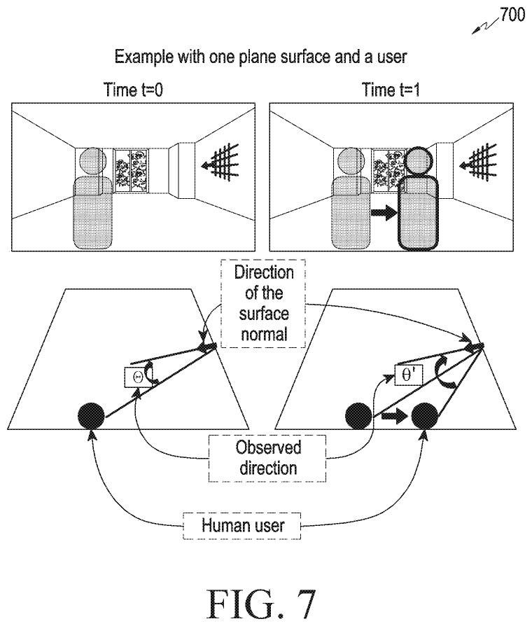

FIG. 7 is an example illustration (700) in which the surface normal estimation is depicted in conjunction with FIG. 6, according to an embodiment of the disclosure.

At the first time interval (t=0), the user is in a first location and at the second time interval (t=1), the user moved bit further and is in a second location. In other words, the can be seen that the observed direction of the surface normal changes when the user changes position. It means observed direction are not equal (i.e., Θ≠Θ′) This change in direction can be used to understand the change in human position

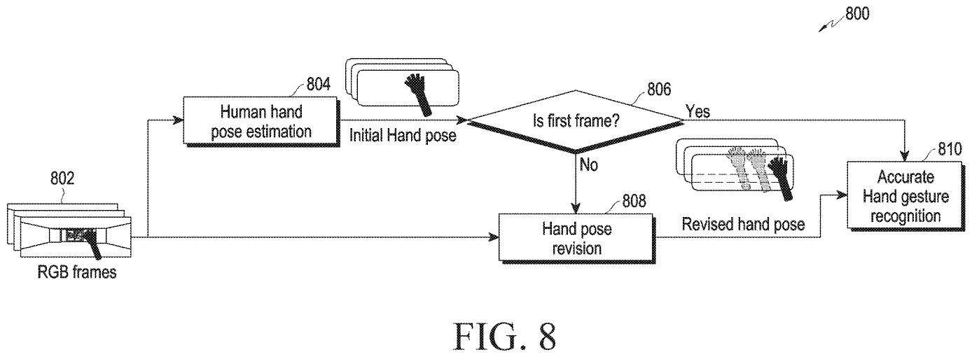

FIG. 8 is an example flow chart illustrating a method for performing the accurate hand gesture recognition based on the surface normal trajectory estimation, according to an embodiment of the disclosure.

At operation 802, the method includes receiving the frames (e.g., red, green, and blue (RGB) frames, YUV frames or the like). At operation 804, the method includes performing the human hand pose estimation. The hand pose estimation from the frames is well known. The proposed method obtains the precise location of hand key-points in the frame given the image (e.g., RGB image, or the like).

At operation 806, the method includes determining whether the frame is first frame. If the frame is not the first frame then, at operation 808, the method includes performing the hand pose revision based on the proposed method. At operation 810, the method includes recognizing the accurate hand gesture. When previous frames are present, the hand pose shall be revised based on trajectories of the surface normal of all the plane surfaces in the scene. The proposed method revises the estimated hand pose by using the surface normal and track their trajectory to revise the hand pose. If the frame is first frame then, at operation 810, the method includes recognizing the accurate hand gesture. The initial frame is sent without any revision.

FIG. 9 is an example illustration 900 in which hand pose revision is estimated, according to an embodiment of the disclosure.

At 902, the method includes obtaining the frame (e.g., RGB frame or the like). At 904, the method includes performing the surface normal estimation. At 906, the method includes performing the plane surface trajectory estimation. The proposed method uses the plane surface normal trajectory estimation as a pre-processing step to hand gesture recognition.

In an example, the plane trajectory estimation is computed as below:
Consider a plane P with normal n in the N^{th} frame.
Let the trajectory at (N−1)^{th} frame be: (x₁, y₁, z₁)
Let n be: (x₂, y₂, z₂)

$$Rotation ( {θ}_{p} ) = {cos}^{- 1} ( \frac{{x}_{1} {x}_{2} + {y}_{1} {y}_{2} + {z}_{1} {z}_{2}}{\sqrt{{x}_{1}^{2} + {y}_{1}^{2} + {z}_{1}^{2}} \sqrt{{x}_{2}^{2} + {y}_{2}^{2} + {z}_{2}^{2}}} )$$

Rotations along axes:

$${R}_{x} ( {θ}_{p} ) = [ \begin{matrix}1 & 0 & 0 \\ 0 & cos θ & - sin θ \\ 0 & sin θ & cos θ\end{matrix} ]$$

$${R}_{y} ( {θ}_{p} ) = [ \begin{matrix}cos θ & 0 & sin θ \\ 0 & 1 & 0 \\ - sin θ & 0 & cos θ\end{matrix} ]$$

$$Translation ( dp ) = ‖ {d}_{2} - {d}_{1} ‖$$

The overall rotation (θ) and translation (d) can be an average of the rotations and translations of the normal of all the planes that are highly correlated.

At 908, the method includes saving the trajectories. At 910, the method includes performing the surface normal based camera motion estimation. The proposed method uses these trajectories to estimate the camera movement and compute the transformation matrix from the estimation. Below is an example for the surface normal based camera motion estimation.

Consider, the warp along axes based on the estimated trajectory

Wₓ=d*Rₓ⁻¹(θ)

W_{y}=d*R_{y}⁻¹(θ)

At 912, the method includes updating the hand pose by comparing with the initial hand pose. The method includes proving the revised hand pose. In an example, using the transformation matrix of the camera, the method transforms the hand pose. Below is an example for the pose update.

Let initial pose be

P=(Pₓ,P_{y})

K=Camera matrix

Corrected pose is

P′ₓ=K·WₓPₓ

P′_{y}=K·W_{y}P_{y}

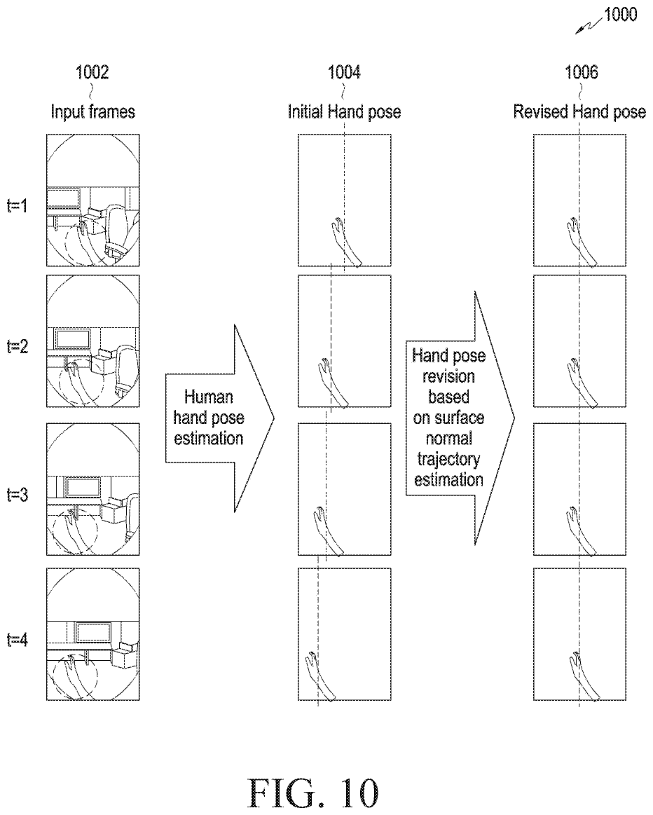

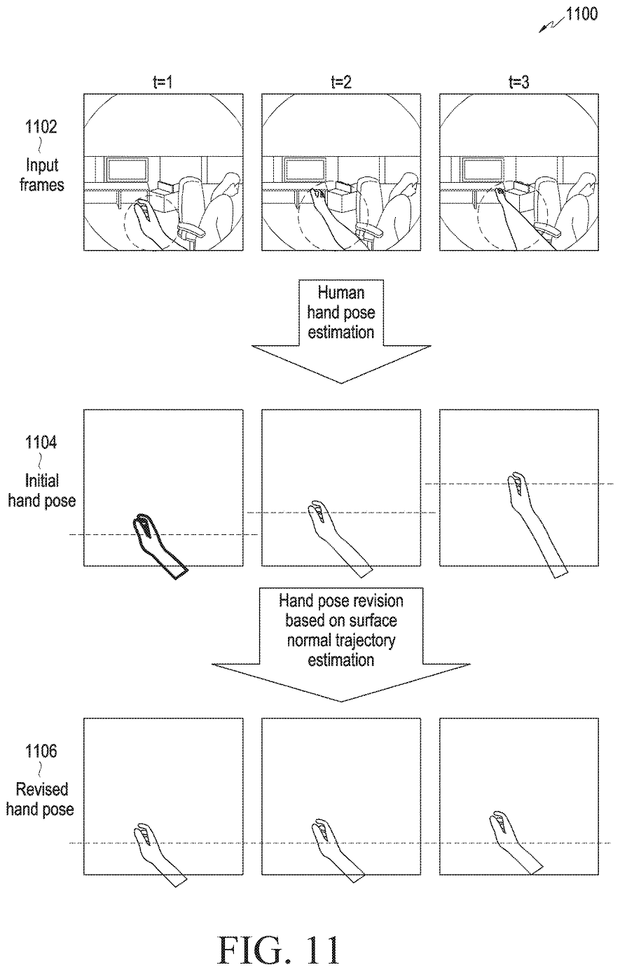

FIGS. 10 and 11 are example illustrations (1000 and 1100) in which the electronic device (200) recognizes the hand gesture, according to various embodiments of the disclosure

Referring to FIG. 10, the sequence of the input frames showcase a single scenario where three possibilities are possible, if the electronic device (200) looks at only the estimated initial hand pose. At operation 1002, the hand is moving from the right direction to the left direction resulting in a swipe left gesture. At operation 1004, the electronic device (200) is moving from the left direction to the right direction resulting in the swipe left gesture. At operation 1006, the hand and the electronic device (200) are moving and the correct gesture needs to be identified based on their movement. The proposed method can be used to precisely identify which of the three possibilities is happening based on the visible surface normal and correctly identify the hand gesture.

Referring to FIG. 11, the sequence of input frames showcases a single scenario where two possibilities are possible if the electronic device look at only the estimated initial hand pose. At operation 1102, the hand is moving forward indicating a grab gesture. At operation 1104, the electronic device (200) is moving backward, in which case the gesture should not be identified as grab. The proposed method can be used to precisely identify which of the two cases is happening based on the visible surface normal and correctly identify the hand gesture.

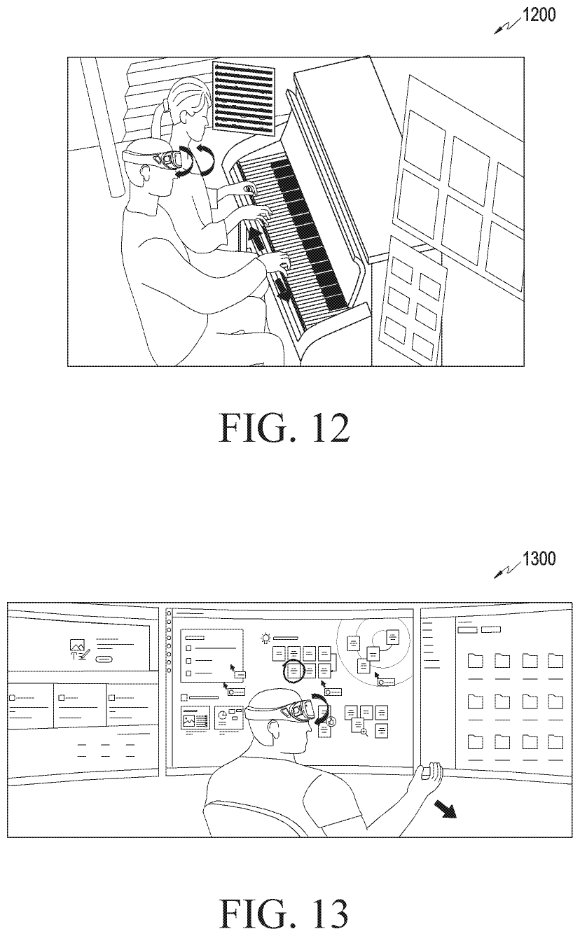

FIG. 12 is an example illustration (1200) in which the HMD moves with the hand while playing a virtual musical instrument, according to an embodiment disclosure.

The VST device allows the users enhanced experiences for playing virtual musical instruments such as piano. The proposed method enables the users to have virtual tutors to help play piano. In these cases, the user's head constantly moves with his fingers (black arrows). The VST device should be able to track the user's hand movement with respect to his/her head, so that accurate notes are produced. The same scenario is applicable to the gaming application.

FIG. 13 is an example illustration (1300) in which the HMD moves with the hand while dragging objects in multiple windows in a virtual desktop/virtual presentations, according to an embodiment of the disclosure.

The HMD allows the users to use their entire Field of view (FOV) to place windows. The user of the HMD may need to drag and drop items from one window to another window. In this scenario, the user will move his/her head along with his/her hand as shown with black arrows. The HMD should be able to track hand movement with respect to the head movement.

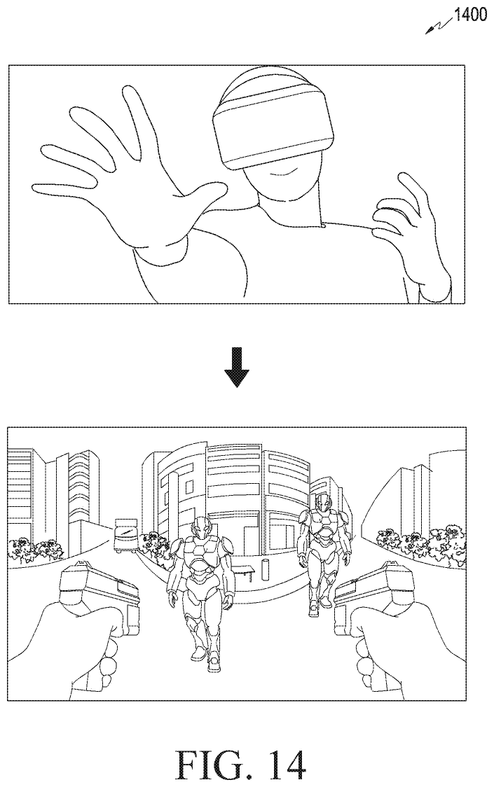

FIG. 14 is example illustration 1400 in which the HMD moves with the hand while playing a VR games, according to an embodiment of the disclosure.

The HMD allows users to use their entire FOV to play VR games. For example, in shooting games, a user of the HMD may need to aim using the HMD and shoot using the hand gestures. In this case, the user of the HMD will move his head/her head along with his hand/her head. The HMD should be able to track hand movement with respect to the head movement.

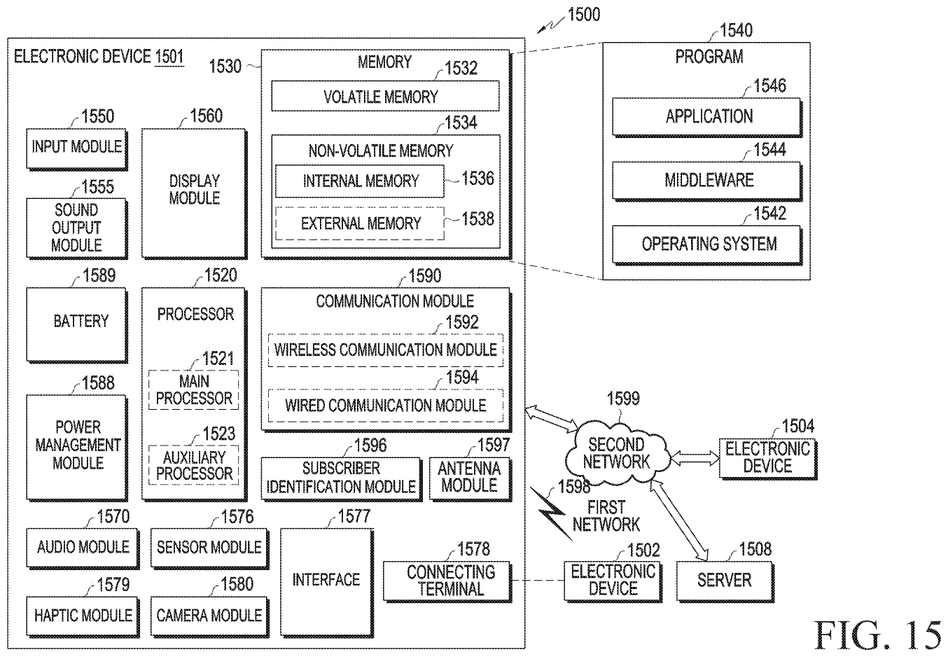

FIG. 15 is a block diagram illustrating an electronic device 1501 in a network environment 1500 according to an embodiment of the disclosure.

Referring to FIG. 15, the electronic device 1501 in the network environment 1500 may communicate with an electronic device 1502 via a first network 1598 (e.g., a short-range wireless communication network), or at least one of an electronic device 1504 or a server 1508 via a second network 1599 (e.g., a long-range wireless communication network). According to an embodiment, the electronic device 1501 may communicate with the electronic device 1504 via the server 1508. According to an embodiment, the electronic device 1501 may include a processor 1520, memory 1530, an input module 1550, a sound output module 1555, a display module 1560, an audio module 1570, a sensor module 1576, an interface 1577, a connecting terminal 1578, a haptic module 1579, a camera module 1580, a power management module 1588, a battery 1589, a communication module 1590, a subscriber identification module (SIM) 1596, or an antenna module 1597. In various embodiments, at least one of the components (e.g., the connecting terminal 1578) may be omitted from the electronic device 1501, or one or more other components may be added in the electronic device 1501. In some embodiments, some of the components (e.g., the sensor module 1576, the camera module 1580, or the antenna module 1597) may be implemented as a single component (e.g., the display module 1560).

The processor 1520 may execute, for example, software (e.g., a program 1540) to control at least one other component (e.g., a hardware or software component) of the electronic device 1501 coupled with the processor 1520, and may perform various data processing or computation. According to an embodiment, as at least part of the data processing or computation, the processor 1520 may store a command or data received from another component (e.g., the sensor module 1576 or the communication module 1590) in volatile memory 1532, process the command or the data stored in the volatile memory 1532, and store resulting data in non-volatile memory 1534. According to an embodiment, the processor 1520 may include a main processor 1521 (e.g., a central processing unit (CPU) or an application processor (AP)), or an auxiliary processor 1523 (e.g., a graphics processing unit (GPU), a neural processing unit (NPU), an image signal processor (ISP), a sensor hub processor, or a communication processor (CP)) that is operable independently from, or in conjunction with, the main processor 1521. For example, when the electronic device 1501 includes the main processor 1521 and the auxiliary processor 1523, the auxiliary processor 1523 may be adapted to consume less power than the main processor 1521, or to be specific to a specified function. The auxiliary processor 1523 may be implemented as separate from, or as part of the main processor 1521.

The auxiliary processor 1523 may, for example control at least some of functions or states related to at least one component (e.g., the display module 1560, the sensor module 1576, or the communication module 1590) among the components of the electronic device 1501, instead of the main processor 1521 while the main processor 1521 is in an inactive (e.g., sleep) state, or together with the main processor 1521 while the main processor 1521 is in an active state (e.g., executing an application). According to an embodiment, the auxiliary processor 1523 (e.g., an image signal processor or a communication processor) may be implemented as part of another component (e.g., the camera module 1580 or the communication module 1590) functionally related to the auxiliary processor 1523. In an embodiment, the auxiliary processor 1523 (e.g., the neural processing unit) may include a hardware structure specified for artificial intelligence model processing. An artificial intelligence model may be generated by machine learning. Such learning may be performed, e.g., by the electronic device 1501 where the artificial intelligence is performed or via a separate server (e.g., the server 1508). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 1530 may store various data used by at least one component (e.g., the processor 1520 or the sensor module 1576) of the electronic device 1501. The various data may include, for example, software (e.g., the program 1540) and input data or output data for a command related thereto. The memory 1530 may include the volatile memory 1532 or the non-volatile memory 1534.

The program 1540 may be stored in the memory 1530 as software, and may include, for example, an operating system (OS) 1542, middleware 1544, or an application 1546.

The input module 1550 may receive a command or data to be used by another component (e.g., the processor 1520) of the electronic device 1501, from the outside (e.g., a user) of the electronic device 1501. The input module 1550 may include, for example, a microphone, a mouse, a keyboard, a key (e.g., a button), or a digital pen (e.g., a stylus pen).

The sound output module 1555 may output sound signals to the outside of the electronic device 1501. The sound output module 1555 may include, for example, a speaker or a receiver. The speaker may be used for general purposes, such as playing multimedia or playing record. The receiver may be used for receiving incoming calls. According to another embodiment, the receiver may be implemented as separate from, or as part of the speaker.

The display module 1560 may visually provide information to the outside (e.g., a user) of the electronic device 1501. The display module 1560 may include, for example, a display, a hologram device, or a projector and control circuitry to control a corresponding one of the display, hologram device, and projector. According to another embodiment, the display module 1560 may include a touch sensor adapted to detect a touch, or a pressure sensor adapted to measure the intensity of force incurred by the touch.

The audio module 1570 may convert a sound into an electrical signal and vice versa. According to an embodiment, the audio module 1570 may obtain the sound via the input module 1550, or output the sound via the sound output module 1555 or a headphone of an external electronic device (e.g., an electronic device 1502) directly (e.g., wiredly) or wirelessly coupled with the electronic device 1501.

The sensor module 1576 may detect an operational state (e.g., power or temperature) of the electronic device 1501 or an environmental state (e.g., a state of a user) external to the electronic device 1501, and then generate an electrical signal or data value corresponding to the detected state. According to an embodiment, the sensor module 1576 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1577 may support one or more specified protocols to be used for the electronic device 1501 to be coupled with the external electronic device (e.g., the electronic device 1502) directly (e.g., wiredly) or wirelessly. In an embodiment, the interface 1577 may include, for example, a high definition multimedia interface (HDMI), a universal serial bus (USB) interface, a secure digital (SD) card interface, or an audio interface.

A connecting terminal 1578 may include a connector via which the electronic device 1501 may be physically connected with the external electronic device (e.g., the electronic device 1502). According to another embodiment, the connecting terminal 1578 may include, for example, a HDMI connector, a USB connector, a SD card connector, or an audio connector (e.g., a headphone connector).

The haptic module 1579 may convert an electrical signal into a mechanical stimulus (e.g., a vibration or a movement) or electrical stimulus which may be recognized by a user via his tactile sensation or kinesthetic sensation. According to an embodiment, the haptic module 1579 may include, for example, a motor, a piezoelectric element, or an electric stimulator.

The camera module 1580 may capture a still image or moving images. According to an embodiment, the camera module 1580 may include one or more lenses, image sensors, image signal processors, or flashes.

The power management module 1588 may manage power supplied to the electronic device 1501. According to one embodiment, the power management module 1588 may be implemented as at least part of, for example, a power management integrated circuit (PMIC).

The battery 1589 may supply power to at least one component of the electronic device 1501. According to another embodiment, the battery 1589 may include, for example, a primary cell which is not rechargeable, a secondary cell which is rechargeable, or a fuel cell.

The communication module 1590 may support establishing a direct (e.g., wired) communication channel or a wireless communication channel between the electronic device 1501 and the external electronic device (e.g., the electronic device 1502, the electronic device 1504, or the server 1508) and performing communication via the established communication channel. The communication module 1590 may include one or more communication processors that are operable independently from the processor 1520 (e.g., the application processor (AP)) and supports a direct (e.g., wired) communication or a wireless communication. According to an embodiment, the communication module 1590 may include a wireless communication module 1592 (e.g., a cellular communication module, a short-range wireless communication module, or a global navigation satellite system (GNSS) communication module) or a wired communication module 1594 (e.g., a local area network (LAN) communication module or a power line communication (PLC) module). A corresponding one of these communication modules may communicate with the external electronic device via the first network 1598 (e.g., a short-range communication network, such as Bluetooth™, wireless-fidelity (Wi-Fi) direct, or infrared data association (IrDA)) or the second network 1599 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 1592 may identify and authenticate the electronic device 1501 in a communication network, such as the first network 1598 or the second network 1599, using subscriber information (e.g., international mobile subscriber identity (IMSI)) stored in the subscriber identification module 1596.

The wireless communication module 1592 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1592 may support a high-frequency band (e.g., the mm Wave band) to achieve, e.g., a high data transmission rate. The wireless communication module 1592 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 1592 may support various requirements specified in the electronic device 1501, an external electronic device (e.g., the electronic device 1504), or a network system (e.g., the second network 1599). According to an embodiment, the wireless communication module 1592 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 1597 may transmit or receive a signal or power to or from the outside (e.g., the external electronic device) of the electronic device 1501. According to another embodiment, the antenna module 1597 may include an antenna including a radiating element composed of a conductive material or a conductive pattern formed in or on a substrate (e.g., a printed circuit board (PCB)). According to an embodiment, the antenna module 1597 may include a plurality of antennas (e.g., array antennas). In such a case, at least one antenna appropriate for a communication scheme used in the communication network, such as the first network 1598 or the second network 1599, may be selected, for example, by the communication module 1590 (e.g., the wireless communication module 1592) from the plurality of antennas. The signal or the power may then be transmitted or received between the communication module 1590 and the external electronic device via the selected at least one antenna. According to an embodiment, another component (e.g., a radio frequency integrated circuit (RFIC)) other than the radiating element may be additionally formed as part of the antenna module 1597.

According to some embodiments, the antenna module 1597 may form a mm Wave antenna module. According to an embodiment, the mm Wave antenna module may include a printed circuit board, a RFIC disposed on a first surface (e.g., the bottom surface) of the printed circuit board, or adjacent to the first surface and capable of supporting a designated high-frequency band (e.g., the mm Wave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

Commands or data may be transmitted or received between the electronic device 1501 and the external electronic device 1504 via the server 1508 coupled with the second network 1599. Each of the electronic devices 1502 or 1504 may be a device of a same type as, or a different type, from the electronic device 1501. According to an embodiment, all or some of operations to be executed at the electronic device 1501 may be executed at one or more of the external electronic devices 1502, 1504, or 1508. For example, if the electronic device 1501 should perform a function or a service automatically, or in response to a request from a user or another device, the electronic device 1501, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1501. The electronic device 1501 may provide the outcome, with or without further processing of the outcome, as at least part of a reply to the request. To that end, a cloud computing, distributed computing, mobile edge computing (MEC), or client-server computing technology may be used, for example. The electronic device 1501 may provide ultra low-latency services using, e.g., distributed computing or mobile edge computing. In another embodiment, the external electronic device 1504 may include an internet-of-things (IoT) device. The server 1508 may be an intelligent server using machine learning and/or a neural network. According to another embodiment, the external electronic device 1504 or the server 1508 may be included in the second network 1599. The electronic device 1501 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 1540) including one or more instructions that are stored in a storage medium (e.g., internal memory 1536 or external memory 1538) that is readable by a machine (e.g., the electronic device 1501). In an example, a processor (e.g., the processor 1520) of the machine (e.g., the electronic device 1501) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to other embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to some embodiments, operations performed by the module, the program, or another component may be carried out sequentially, in parallel, repeatedly, or heuristically, or one or more of the operations may be executed in a different order or omitted, or one or more other operations may be added.

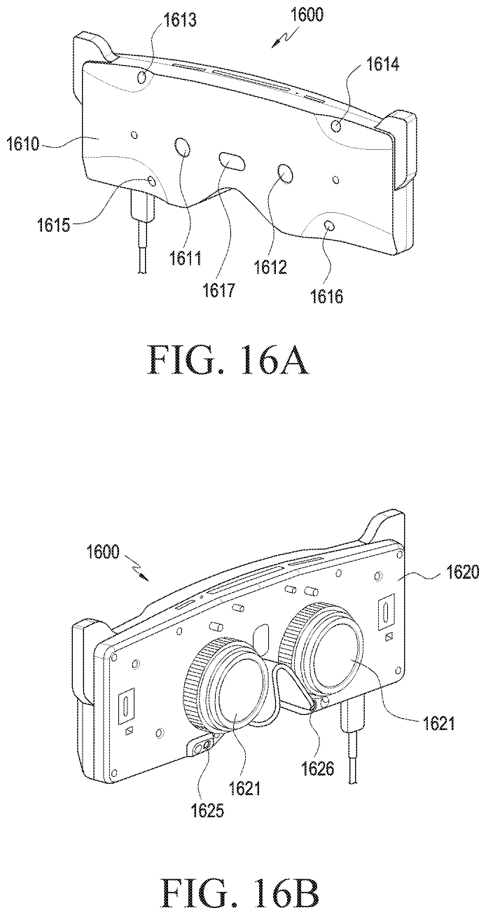

FIGS. 16A and 16B are diagrams illustrating a wearable device (1600) (e.g., the electronic device (200)) according to various embodiments of the disclosure.

Referring to FIGS. 16A and 16B, in an embodiment, camera modules 1611, 1612, 1613, 1614, 1615, and 1616 and/or a depth sensor 1617 for obtaining information related to the surrounding environment of the wearable device (1600) (e.g., the electronic device (200)) may be disposed on a first surface 1610 of the housing. In an embodiment, the camera modules 1611 and 1612 may obtain an image related to the surrounding environment of the wearable device. In an embodiment, the camera modules 1613, 1614, 1615, and 1616 may obtain an image while the wearable device is worn by the user. Images obtained through the camera modules 1613, 1614, 1615, and 1616 may be used for simultaneous localization and mapping (SLAM), 6 degrees of freedom (6DoF), 3 degrees of freedom (3DoF), subject recognition and/or tracking, and may be used as an input of the wearable electronic device by recognizing and/or tracking the user's hand. In an embodiment, the depth sensor 1617 may be configured to transmit a signal and receive a signal reflected from a subject, and may be used to identify the distance to an object, such as time of flight (TOF). Face recognition camera modules 1625 and 1626 and/or a display 1621 (and/or a lens) may be disposed on the second surface 1620 of the housing. In an embodiment, the face recognition camera modules 1625 and 1626 adjacent to the display may be used for recognizing a user's face or may recognize and/or track both eyes of the user. In an embodiment, the display 1621 (and/or lens) may be disposed on the second surface 1620 of the wearable device (1600). In an embodiment, the wearable device (1600) may not include the camera modules 1615 and 1616 among a plurality of camera modules 1613, 1614, 1615, and 1616. As described above, the wearable device (1600) according to an embodiment may have a form factor for being worn on the user's head. The wearable device (1600) may further include a strap for being fixed on the user's body and/or a wearing member. The wearable device may provide a user experience based on augmented reality, virtual reality, and/or mixed reality within a state worn on the user's head.

The various actions, acts, blocks, steps, or the like in the flow charts (300, 400 and 800) may be performed in the order presented, in a different order or simultaneously. Further, in some embodiments, some of the actions, acts, blocks, steps, or the like may be omitted, added, modified, skipped, or the like without departing from the scope of the disclosure.

The embodiments disclosed herein can be implemented through at least one software program running on at least one hardware device and performing network management functions to control the network elements.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method for determining a gesture of a user, the method comprising:
capturing, by an electronic device, a plurality of frames including a part of a body of the user;
estimating, by the electronic device, a plurality of background planes for each frame of the plurality of frames;
based on the estimation, identifying, by the electronic device, a movement of the plurality of background planes;
based on the identifying of the movement of the plurality of background planes, estimating, by the electronic device, a movement direction of the electronic device; and
based on the estimated movement direction of the electronic device, determining, by the electronic device, the gesture of the user while the gesture is detected by the electronic device.

2. The method of claim 1,
wherein the plurality of background planes is estimated based on a surface normal estimation, and
wherein the surface normal estimation is performed by detecting at least one feature in the captured plurality of frames.

3. The method of claim 2, wherein the surface normal estimation is performed by using a data driven model.

4. The method of claim 1,
wherein the movement of the plurality of background planes in each of the frames is stored in memory of the electronic device, and
wherein the stored movement of the plurality of background planes is referred as a reference movement used to determine an exact hand gesture.

5. The method of claim 1, wherein the gesture is detected while the electronic device is moving along with the part of the body of the user.

6. A method for determining a gesture of a user, the method comprising:
capturing, by an electronic device, a plurality of frames including a part of a body of the user;
detecting, by the electronic device, that the electronic device is moving along with the part of a body;
obtaining, by the electronic device, a surface plane information to estimate a plurality of background planes associated with each frame of the plurality of frames;
measuring, by the electronic device, a movement of the plurality of background planes to estimate a movement direction of the electronic device;
determining, by the electronic device, a relative motion between the electronic device and the part of the body by correlating the surface plane information and the movement of the plurality of background planes; and
determining, by the electronic device, the gesture based on the determined relative motion.

7. The method of claim 6,
wherein the surface plane information is performed by detecting at least one feature in the captured plurality of frames, and
wherein the surface plane information is performed by using a data driven model.

8. The method of claim 6,
wherein the movement of the plurality of background planes in each of the frames is stored in memory of the electronic device, and
wherein the stored movement of the plurality of background planes is referred as a reference movement used to determine an exact hand gesture.

9. An electronic device, comprising:
memory, comprising one or more storage media, storing instructions; and
at least one processor communicatively coupled to the memory,
wherein the instructions, when executed by the at least one processor individually or collectively, cause the electronic device to:
capture, by the electronic device, a plurality of frames including a part of a body of a user,
estimate, by the electronic device, a plurality of background planes for each frame of the plurality of frames,
based on the estimation, identify, by the electronic device, a movement of the plurality of background planes,
based on the identifying of the movement of the plurality of background planes, estimate, by the electronic device, a movement direction of the electronic device, and
based on the estimated movement direction of the electronic device, determine, by the electronic device, a gesture of the user while the gesture is detected by the electronic device.

10. The electronic device of claim 9,
wherein the plurality of background planes is estimated based on a surface normal estimation, and
wherein the surface normal estimation is performed by detecting at least one feature in the captured plurality of frames.

11. The electronic device of claim 10, wherein the surface normal estimation is performed by using a data driven model.

12. The electronic device of claim 9,
wherein the movement of the plurality of background planes in each of the frames is stored in the memory, and
wherein the stored movement of the plurality of background planes is referred as a reference movement used to determine an exact hand gesture.

13. The electronic device of claim 9, wherein the gesture is detected while the electronic device is moving along with the part of the body of the user.

14. An electronic device, comprising:
memory, comprising one or more storage media, storing instructions; and
at least one processor communicatively coupled to the memory,
wherein the instructions, when executed by the at least one processor individually or collectively, cause the electronic device to:
capture a plurality of frames including a part of a body of a user,
detect that the electronic device is moving along with the part of the body,
obtain a surface plane information to estimate a plurality of background planes associated with each frame of the plurality of frames,
measure a movement of the plurality of background planes to estimate a movement direction of the electronic device,
determine a relative motion between the electronic device and the part of the body by correlating the surface plane information and the movement of the plurality of background planes, and
based on the determined relative motion, determine a gesture.

15. The electronic device of claim 14,
wherein the surface plane information is performed by detecting at least one feature in the captured plurality of frames, and
wherein the surface plane information is performed by using a data driven model.

16. The electronic device of claim 14,
wherein the movement of the plurality of background planes in each of the frames is stored in the memory, and
wherein the stored movement of the plurality of background planes is referred as a reference movement used to determine an exact hand gesture.

17. One or more non-transitory computer-readable storage media storing one or more computer programs including computer-executable instructions that, when executed by at least one processor of an electronic device individually or collectively, cause the electronic device to perform operations, the operations comprising:
capturing, by an electronic device, a plurality of frames including a part of a body of a user;
estimating, by the electronic device, a plurality of background planes for each frame of the plurality of frames;
based on the estimation, identifying, by the electronic device, a movement of the plurality of background planes;
based on the identifying of the movement of the plurality of background planes, estimating, by the electronic device, a movement direction of the electronic device; and
based on the estimated movement direction of the electronic device, determining, by the electronic device, a gesture of the user while the gesture is detected by the electronic device.

18. The one or more non-transitory computer-readable storage media of claim 17,
wherein the plurality of background planes is estimated based on a surface normal estimation, and
wherein the surface normal estimation is performed by detecting at least one feature in the captured plurality of frames.
